(19) United States
(12) Patent Application Publication
(10) Pub. No.: US 2009/0029234 A1
(43) Pub. Date: Jan. 29, 2009

(54) Method of manufacturing membrane electrode assembly, and membrane electrode assembly

(75) Inventors: Masao Okumura, Toyota-shi (JP); Noriyuki Kobayashi, Susono-shi (JP); Toru Ikeda, Toyota-shi (JP); Tatsuya Hatanaka, Aichi-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/219,107

(22) Filed: Jul. 16, 2008

(30) Foreign Application Priority Data
Jul. 23, 2007 (JP) 2007-190600

(51) Int. Cl. H01M 4/00; B05D 5/12

(52) U.S. Cl. 429/40; 427/58

(57) ABSTRACT

A method of manufacturing a membrane electrode assembly for a fuel cell includes: producing a gas diffusion layer powder that is used to form a gas diffusion layer; forming a catalyst layer on an electrolyte membrane; and forming the gas diffusion layer on the catalyst layer by depositing the gas diffusion layer powder on the catalyst layer.

### INCORPORATION BY REFERENCE

The disclosure of Japanese Patent Application No. 2007-190600 filed on Jul. 23, 2007, including the specification, drawings and abstract is incorporated herein by reference in its entirety.

### BACKGROUND OF THE INVENTION

1. Field of the Invention

The invention relates to a technology for manufacturing a membrane electrode assembly for a fuel cell.

2. Description of the Related Art

A fuel cell may include a membrane electrode assembly (hereinafter referred to as “MEA”) that includes an electrolyte membrane, a catalyst layer formed on each side of the electrolyte membrane, and a gas diffusion layer formed on the catalyst layer. In the gas diffusion layer, reaction gas supplied to the MEA, for example, oxidation gas, is diffused in a manner such that the reaction gas is supplied to the entire area of the MEA, and water generated through an electrochemical reaction occurring in the catalyst layer is discharged from the gas diffusion layer. Japanese Patent Application Publication No. 2003-203646 (JP-A-2003-203646) describes the gas diffusion layer that includes a water-repellent layer formed by applying paste, which contains the water-repellent material, on a conductive base material in a thin sheet form, such as carbon paper or carbon cloth.

There is a demand for reducing the thickness of the MEA in order to make the fuel cell more compact. Further, there is also a demand for reducing the thickness of the gas diffusion layer in order to improve water discharge performance of the gas diffusion layer and reduce electrical resistance of the gas diffusion layer. However, when the gas diffusion layer is formed as described above, the gas diffusion layer includes two layers. One of the two layers is the layer of the base material, and the other is the layer of the water-repellent material paste. Therefore, compared to the gas diffusion layer formed of a single layer, the gas diffusion layer including the two layers is relatively thick. Further, in order to maintain the base material in the sheet form, the strength of the base material needs to be increased to a necessary extent, and therefore it is very difficult to make the base material very thin.

### SUMMARY OF THE INVENTION

The invention provides a technology to form a thin gas diffusion layer in a membrane electrode assembly for a fuel cell.

A first aspect of the invention relates to a method of manufacturing a membrane electrode assembly for a fuel cell. The method includes: producing a gas diffusion layer powder that is used to form a gas diffusion layer; forming a catalyst layer on an electrolyte membrane; and forming the gas diffusion layer on the catalyst layer by depositing the gas diffusion layer powder on the catalyst layer.

In the method according to the first aspect of the invention, the gas diffusion layer is formed by forming a deposit of the gas diffusion layer powder, and therefore it is possible to reduce the thickness of the gas diffusion layer by reducing the amount of the deposited gas diffusion layer powder.

A second aspect of the invention relates to a membrane electrode assembly for a fuel cell. The membrane electrode assembly includes: a catalyst layer formed by depositing a catalyst powder, which contains a catalyst-supported particle and an electrolyte, on an electrolyte membrane; and a gas diffusion layer formed by depositing a gas diffusion layer powder, which contains a conductive material, on the catalyst layer.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a flowchart showing the procedure of a MEA manufacturing method according to an embodiment of the invention;

FIG. 2 schematically shows the detailed procedure of the process in step S105 in the flowchart shown in FIG. 1;

FIG. 3 schematically shows the detailed procedure of the process in step S110 in the flowchart shown in FIG. 1;

FIG. 4 schematically shows a method of forming a deposit of a catalytic layer powder 600 in step S115a;

FIG. 5 schematically shows a method of forming a deposit of a gas diffusion layer powder 300 in step S120a;

FIG. 6 schematically shows the configuration of a fuel cell including the MEA manufactured using the method shown in FIG. 1; and

FIG. 7 is a chart showing the I-V characteristics (“I” stands for current density, and “V” stands for voltage) of a fuel cell 100 produced in an example and the I-V characteristics of a fuel cell produced in a comparative example.

### DETAILED DESCRIPTION OF THE PREFERRED EMBODIMENTS

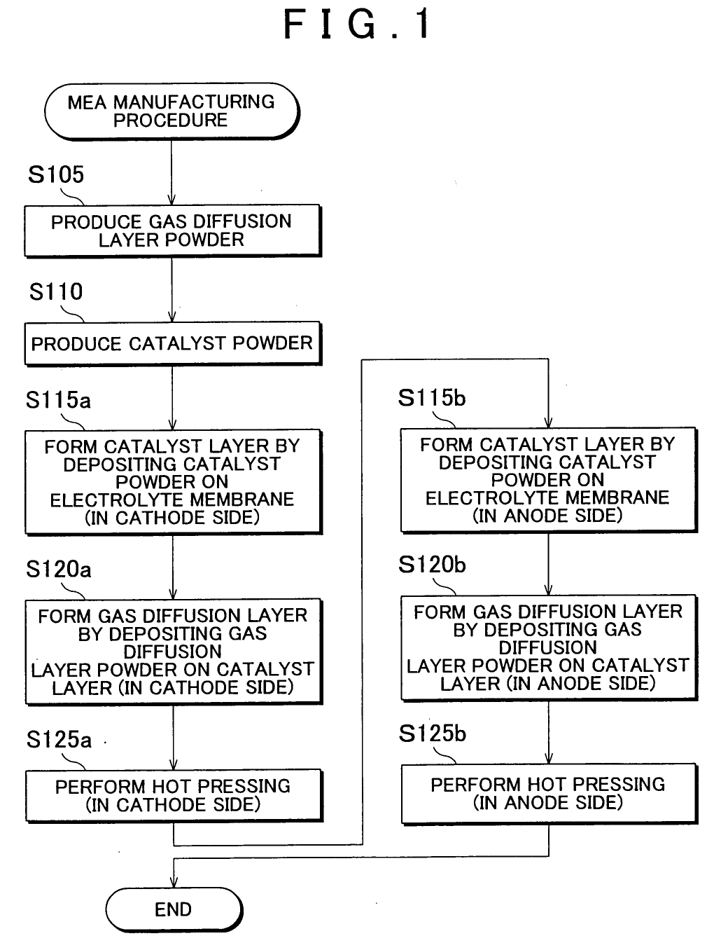

FIG. 1 is a flowchart showing the procedure of a MEA manufacturing method according to an embodiment of the invention. In step S105 in the flowchart, composite powder (gas diffusion layer powder) in which a conductive material and a water-repellent material are combined is produced as the powder used to form a gas diffusion layer of the MEA.

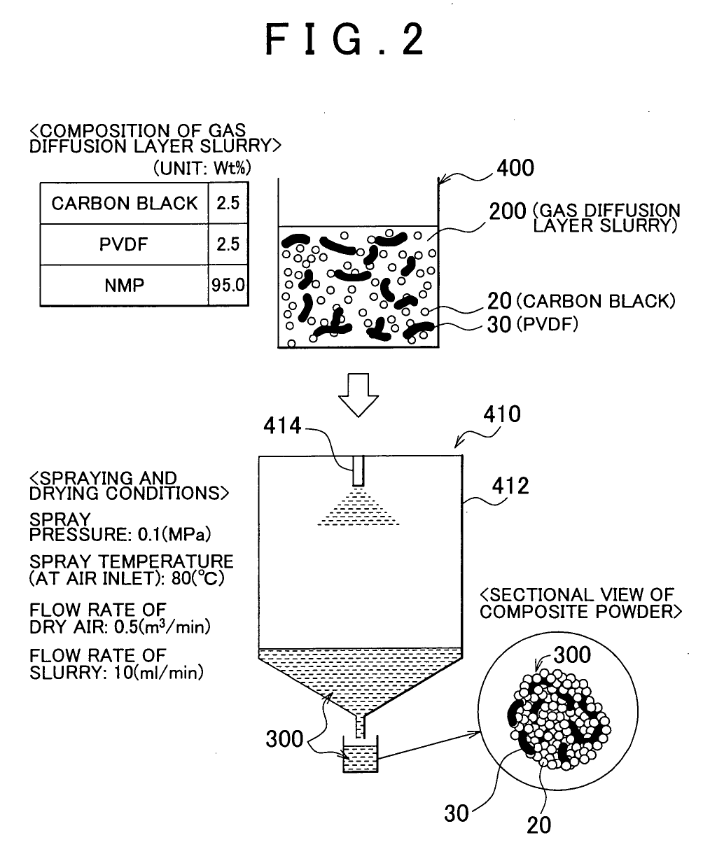

FIG. 2 schematically shows the detailed procedure of the process in step S105 in the flowchart shown in FIG. 1. As exemplified in FIG. 2, carbon black 20, which functions as the conductive material, and polyvinylidene fluoride (PVDF) 30, which functions as the water-repellent material, are added to a mixed solvent. The mixed solvent is the mixture of water and N-Methylpyrrolidone (NMP) that functions as a solvent. The carbon black 20 and PVDF 30 are mixed and diffused in the mixed solvent, whereby a gas diffusion layer slurry 200 is obtained. As a composition of the gas diffusion layer slurry 200, a weight ratio between the carbon black 20 and PVDF 30 (carbon black:PVDF) may be in the range of 1:9 to 8:2. However, it is preferable that the weight ratio between the carbon black 20 and PVDF 30 be in the range of 4:6 to 6:4.

As an example of the conductive material, DENKA BLACK (acetylene black) made by Denka Kagaku Kogyo Kabushiki Kaisha, may be used. Further, the conductive material is not limited to the acetylene black, and any type of carbon black, such as channel black, thermal black, and furnace black, may also be used. Yet further, the conductive material is not limited to the carbon black, and carbon nanofiber, such as VGCF (registered trademark), carbon nanotube (CNT), or carbon nanohorn (CNH), may also be used. Further, the conductive material is not limited to a carbon-based material, and a metal powder, such as a Ti powder, a Pt powder, or an Au powder, may also be used. The water-repellent material is not limited to PVDF as described above, and any water-repellent (hydrophobic) material, such as polyvinyl fluoride (PVF), polyhexafluoropropylene (for example, fluorinated ethylene propylene (FEP)), or polytetrafluoroethylene, may be used.

The gas diffusion layer powder is produced by spraying and drying the gas diffusion layer slurry 200 by a spray-drying method using a spray drier. More specifically, the gas diffusion layer slurry 200 is sprayed into a chamber 412 using an atomizer 414 included in a spray drier 410, and the mist of the sprayed gas diffusion layer slurry 200 is brought into contact with the dried air so that the gas diffusion layer slurry 200 is instantaneously dried, whereby a gas diffusion layer powder 300 is obtained. The gas diffusion layer powder 300 thus obtained is the composite powder of the carbon black 20 and PVDF 30. The diameter of a particle of the gas diffusion layer powder 300 may be in the range of approximately 1 μm to 12 μm, and preferably in the range of approximately 2 μcm to 7 μm. The diameter of the particle of the gas diffusion layer powder 300 is adjusted by changing spraying conditions or/and the composition of the gas diffusion layer slurry 200.

In step S110 (in the flowchart in FIG. 1), a composite powder (catalyst powder) in which catalyst-supported particles and an electrolyte are combined is produced as the powder used to form a catalytic layer. Note that, it is possible to simultaneously perform the process in step S110 and the process in step S105, or to perform the process in step S105 and the process in step S110 in a reverse order to the order described herein.

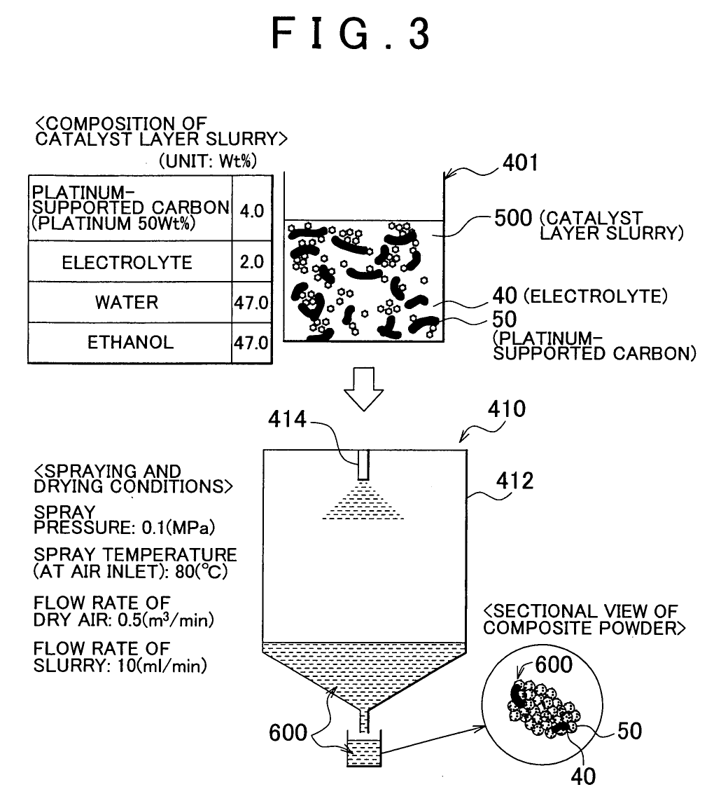

FIG. 3 schematically shows the detailed procedure of the process in step S110 in the flowchart shown in FIG. 1. As exemplified in FIG. 3, platinum-supported carbon 50 (platinum 50 Wt %), which functions as the catalyst-supported particles, and Nafion (registered trademark), which functions as an electrolyte 40, are added to a mixed solvent. The mixed solvent is the mixture of water and ethanol. The platinum-supported carbon 50 and Nafion are mixed and diffused in the mixed solvent, whereby a catalyst layer slurry 500 is obtained. Then, a catalyst powder 600 is produced by spraying and drying the catalyst layer slurry 500 by the spray-drying method, in a manner similar to the manner in which the gas diffusion layer powder 300 is produced. The catalyst powder 600 thus obtained is the composite powder in which the platinum-supported carbon 50 and the electrolyte 40 are combined.

In step S115a (in the flowchart in FIG. 1), a catalyst layer is formed on a surface of an electrolyte membrane in a cathode side by forming a deposit of the catalyst powder 600 produced in step S110. More specifically, the catalyst powder 600 (shown in FIG. 3) is dropped on the electrolyte membrane through a screen by electrostatic screening so as to deposit the catalyst powder 600 on the electrolyte membrane. Here, it should be noted that for example, Nafion (registered trademark) made by DuPont, Aciplex (registered trademark) made by Asahi Kasei Corporation, or Flemion (registered trademark) made by Asahi Glass Co., Ltd. may be used as the electrolyte membrane.

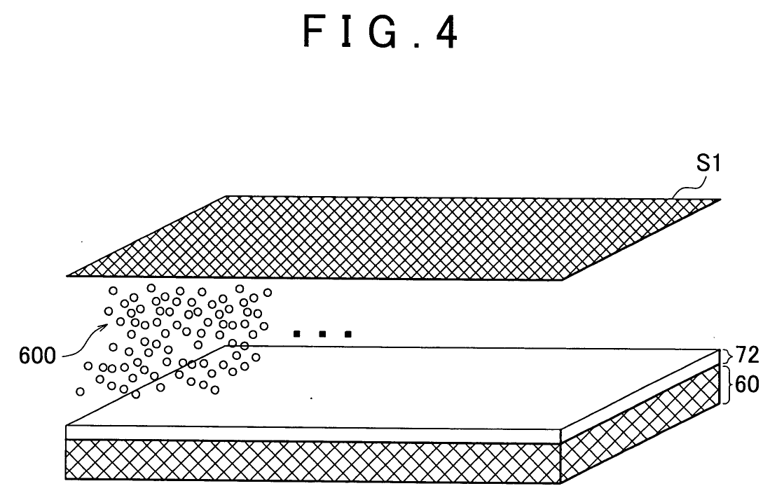

FIG. 4 schematically shows a method of forming a deposit of the catalytic layer powder 600 in step S115a. In a screen S1 used in this deposition process, openings are formed in an entire area through which the powder passes (hereinafter referred to as “powder-passing area”). The openings are large enough to allow the particles of the catalyst powder 600 to pass through the powder-passing area of the screen S1. Synthetic fiber, such as nylon, or metallic fiber made by, for example, weaving metallic wires, such as stainless steel wires, may be used as the material for the screen S1. The catalyst powder 600 is deposited on a surface of the electrolyte membrane 60 in a cathode side by electrostatic screening using the screen S1. More specifically, high voltage is applied to the screen S1, which is positioned away from the electrolyte membrane 60, to produce an electrostatic field between the screen S1 and the electrolyte membrane 60, and the catalyst powder 600 is dropped toward the screen S1. Because the electrostatic field is produced, the catalyst powder 600 is dropped on the surface of the electrolyte membrane 60, which functions as a counter electrode, through the screen S1. In this way, a layer of the catalyst powder 600 (hereinafter referred to as a “cathode-side catalyst layer 72”) with a substantially uniform thickness is formed on the electrolyte membrane 60.

In step S120a (in the flowchart in FIG. 1), a cathode-side gas diffusion layer is formed on the cathode-side catalyst layer 72 formed in step S115a by depositing the gas diffusion layer powder 300 produced in step S105 on the cathode-side catalyst layer 72. In this process, the gas diffusion layer powder 300 (shown in FIG. 2) is dropped on the cathode-side catalyst layer 72 through a screen S2 by electrostatic screening so as to deposit the gas diffusion layer powder 300 on the cathode-side catalyst layer 72, in a manner similar to the manner in which the above-described process in step S115a is performed.

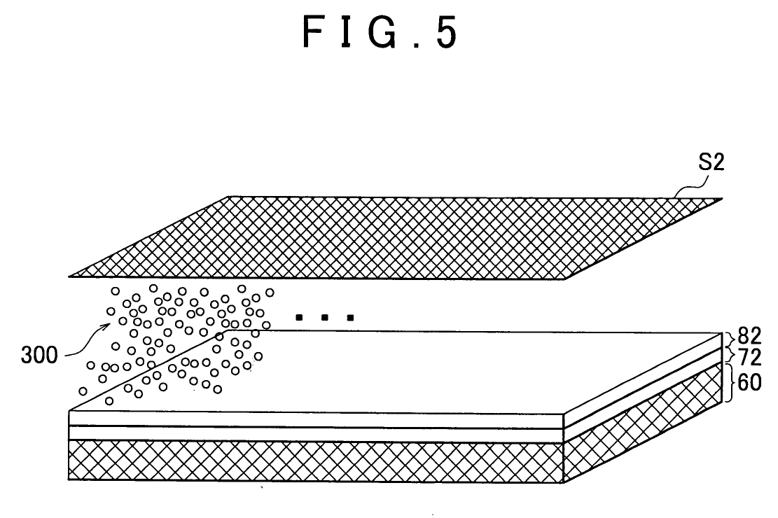

FIG. 5 schematically shows a method of forming a deposit of the gas diffusion layer powder 300 in step S120a. In the screen S2 used in this deposition process, openings are formed in the entire powder-passing area. The openings are large enough to allow the particles of the gas diffusion layer powder 300 to pass through the powder-passing area of the screen S2. The same and similar materials as those for the screen S1 (shown in FIG. 4) may be used as the material for the screen S2. The gas diffusion layer powder 300 is dropped on the cathode-side catalyst layer 72 through the screen S2, thereby forming a layer of the gas diffusion layer powder 300 (hereinafter referred to as a “cathode-side gas diffusion layer 82”) on the cathode-side catalyst layer 72.

In step S125a (shown in FIG. 1), the electrolyte membrane 60 on which the cathode-side catalyst layer 72 and the cathode-side gas diffusion layer 82 are formed is hot-pressed.

In step S115b, the same process as in step S115a is performed to form an anode-side catalyst layer 73 on the surface of the electrolyte membrane 60. Further, in step S120b, the same process as in step S120a is performed to form an anode-side gas diffusion layer 83 on the anode-side catalyst layer 73. Further, in step S125b, the electrolyte membrane 60 on which the anode-side catalyst layer 73 and the anode-side gas diffusion layer 83 are formed is hot-pressed, in a manner similar to the manner in which the process in step S125a is performed. The anode-side catalyst layer 73 and the anode-side gas diffusion layer 83 may be formed on the surface of the electrolyte membrane 60 prior to the formation of the cathode-side catalyst layer 72 and the cathode-side gas diffusion layer 83.

When the MEA is produced in the procedure described above, a base material, such as carbon paper, is no longer required for forming the gas diffusion layer, and thus it is possible to form the gas diffusion layer as a single layer, thereby making the gas diffusion layer relatively thin. Further, the gas diffusion layer is formed by forming a deposit of the gas diffusion layer powder 300, and therefore it is possible to adjust the thickness of the gas diffusion layer powder 300, that is, the thickness of the gas diffusion layer, by adjusting the amount of the deposited gas diffusion layer powder 300. Therefore, if the amount of the deposited gas diffusion layer powder 300 is reduced to an extremely small amount, it is possible to make the thickness of the gas diffusion layer very thin. In addition, the method of forming the gas diffusion layer and the method of forming the catalyst layer are the same (i.e. electrostatic screening). Therefore, it is possible to improve the efficiency of manufacturing the MEA, compared to the MEA manufacturing method in which the gas diffusion layer and the catalyst layer are formed in completely different processes.

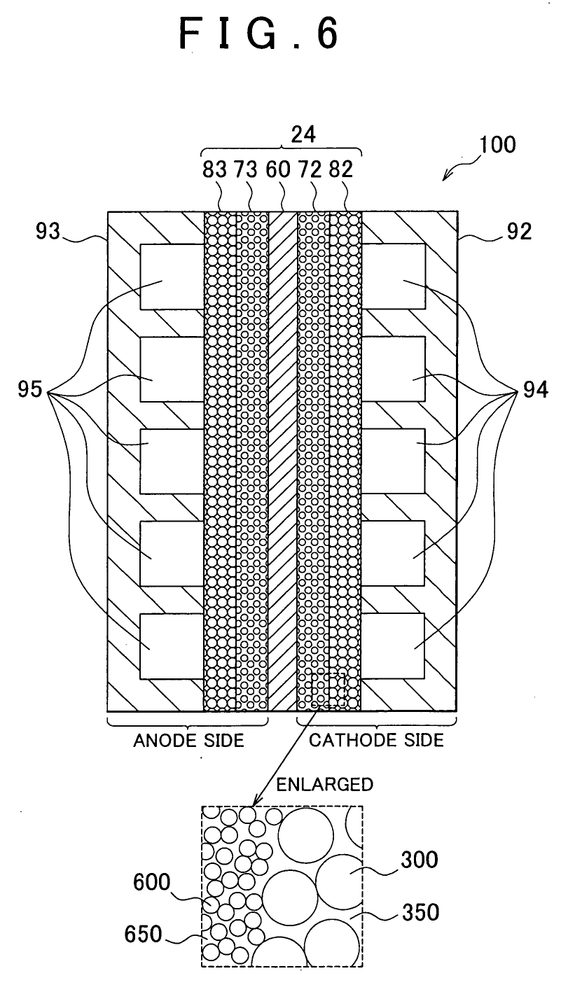

FIG. 6 schematically shows the configuration of a fuel cell including the MEA manufactured using the method shown in FIG. 1. A fuel cell 100 includes a MEA 24, a cathode-side separator 92, and an anode-side separator 93. Each of the cathode-side separator 92 and the anode-side separator 93 is made of a stainless steel sheet. The cathode-side separator 92 and the anode-side separator 93 are disposed with the MEA 24 interposed therebetween. The MEA 24 is manufactured by the manufacturing method shown in FIG. 1. In other words, the MEA 24 includes: the electrolyte membrane 60; the cathode-side catalyst layer 72 formed on the outer surface of the electrolyte membrane 60 in the cathode side; the anode-side catalyst layer 73 formed on the opposite surface of the electrolyte membrane 60 to the surface on which the cathode-side catalyst layer 72 is formed; the cathode-side gas diffusion layer 82 formed on the outer surface of the cathode-side catalyst layer 72; and the anode-side gas diffusion layer 83 formed on the outer surface of the anode-side catalyst layer 73. The cathode-side separator 92 has an uneven surface, and oxidation gas passages 94 are formed between the cathode-side gas diffusion layer 82 and the cathode-side separator 92 so that oxidation gas flows through the oxidation gas passages 94. Similarly, fuel gas passages 95 are formed between the anode-side gas diffusion layer 83 and the anode-side separator 93 so that fuel gas flows through the fuel gas passages 95.

As exemplified in FIG. 6, gaps between the particles of the gas diffusion layer powder 300, which forms the cathode-side gas diffusion layer 82, function as air holes 350. The air holes 350 function as passages through which reaction gas flows and from which produced water is discharged. As exemplified in FIG. 6, the air holes 350 between the particles of the gas diffusion layer powder 300 are relatively large because the diameter of each particle is relatively large. Therefore, it is possible to achieve high gas diffusivity and high water discharge performance. The anode-side gas diffusion layer 83 has the same air holes.

In the cathode-side catalyst layer 72, gaps between the particles of the catalyst powder 600 function as air holes 650. As exemplified in FIG. 6, the air holes 650 are smaller than the air holes 350. The anode-side catalyst layer 73 includes the same air holes that are smaller than the air holes of the anode-side gas diffusion layer 83. If the size of the air holes in the catalyst layer is much smaller than the size of air holes in the gas diffusion layer, (for example, the size of the air holes in the catalyst layer is equal to or smaller than one-tenth of the size of the air holes in the gas diffusion layer), it is difficult for the reaction gas, which has flown into the gas diffusion layer, to flow into the catalyst layer through the air holes. This results in deterioration of the power generation efficiency, because most of the reaction gas that has flown into the gas diffusion layer is discharged, without being used in the catalyst layer. However, as exemplified in FIG. 6, the size difference between the air holes 650 and the air holes 350 in the embodiment is relatively reduced. For example, the size of the air holes 650 is approximately one-half to one-third of the size of the air holes 350. Therefore, the diffusivity of the reaction gas is not deteriorated, thereby suppressing deterioration of the power generation efficiency. The size difference between the air holes 350 and the air holes 650 is cause by the difference between the particle diameter of the gas diffusion layer powder 300 and the particle diameter of the catalyst powder 600. Therefore, in steps S105, S110 in the MEA manufacturing procedure (i.e. in the flowchart shown in FIG. 1), if the gas diffusion layer powder 300 and the catalyst powder 600 are produced so that the particle diameter of the catalyst powder 600 is smaller than the particle diameter of the gas diffusion layer powder 300 (that is, the particle diameter of the gas diffusion layer powder 300 is larger than the particle diameter of the catalyst powder 600) in a manner such that the size difference between the gas diffusion power 300 and the catalyst powder 600 does not become significantly large, it is possible to manufacture the MEA with good power generation efficiency, because deterioration of the power generation efficiency is suppressed. For example, the particle diameter of the gas diffusion layer powder 300 may be approximately two to three times larger than the particle diameter of the catalyst powder 600.

Example: The MEA 24 (configured as shown in FIG. 6) was manufactured according to the flowchart shown in FIG. 1, and the fuel cell 100 was manufactured using the thus manufactured MEA 24. In step S105 (in the flowchart shown in FIG. 1), DENKA BLACK (made by Denka Kagaku Kogyo Kabushiki Kaisha), which functions as the carbon black, and PVDF, which functions as the water-repellent material, were added to the solvent containing NMP in a mixing container 400 (as shown in FIG. 2), and diffused in the solvent so as to produce the gas diffusion layer slurry 200. In this process, the aforementioned materials were mixed so as to produce the gas diffusion layer slurry 200 with the following composition: the carbon black (DENKA BLACK) 2.5 Wt %; PVDF 2.5 Wt %; and NMP 95 Wt %. Then, the gas diffusion layer slurry 200 was sprayed and dried according to the following spraying conditions so as to produce the gas diffusion layer powder 300: a spray pressure was 0.1 Mpa (the spray pressure signifies the pressure used when the gas diffusion layer slurry 200 is sprayed from the atomizer 414 into the chamber 412); a spray temperature (at an air inlet) was 80° C. (the spray temperature (at the air inlet) signifies the temperature of the dry air used for drying the sprayed gas diffusion layer slurry 200, when the dry air is supplied into the chamber 412); the flow rate of the dry air was 0.5 m³/min; and the flow rate of the slurry was 10 ml/min. The average particle diameter of the gas diffusion layer powder 300 thus produced was approximately 6 μm.

In step S110 (in the flowchart shown in FIG. 1), the platinum-supported carbon (platinum 50 Wt %) and Nafion (registered trademark) that functions as the electrolyte were added to the mixed solvent of water and ethanol in a mixing container 401 (as shown in FIG. 3), and the solution obtained by adding the platinum-supported carbon and Nafion to the mixed solvent was stirred to produce the catalyst layer slurry 500. In this process, the materials were mixed so as to produce the catalyst layer slurry 500 with the following composition: the platinum-supported carbon 4.0 Wt %; the electrolyte 2.0 Wt %; water 47.0 Wt %; and ethanol 47.0 Wt %. Then, the catalyst layer slurry 500 was sprayed using the spray drier 410 using the same spraying conditions as that used in the aforementioned step S105, whereby the catalyst powder 600 was obtained. The average particle diameter of the thus produced catalyst powder 600 was approximately 2 μm.

In steps S115a, S115b (in the flowchart shown in FIG. 1), the catalyst powder 600 was deposited on the electrolyte membrane 60 using the screen S1 (shown in FIG. 4) so that the platinum content was 0.5 g/cm². The thickness of the cathode-side catalyst layer 72 was approximately 10 μm. In steps S120a, S120b (in the flowchart shown in FIG. 1), the gas diffusion layer powder 300 was deposited on the cathode-side catalyst layer 72 using the screen S2 (shown in FIG. 5) so that the density of the gas diffusion layer powder 300 was 0.5 mg/cm². The thickness of the cathode-side gas diffusion layer 82 was approximately 80 μm.

In steps S125a, S125b (in the flowchart shown in FIG. 1), hot pressing was performed using a planar press machine (not shown) according to the following pressing conditions: the temperature was 130° C.; the pressure was 4 Mpa; and pressing time was 5 minutes. The MEA 24 (shown in FIG. 6) thus manufactured was interposed between the cathode-side separator 92 and the anode-side separator 93 to form the fuel cell 100.

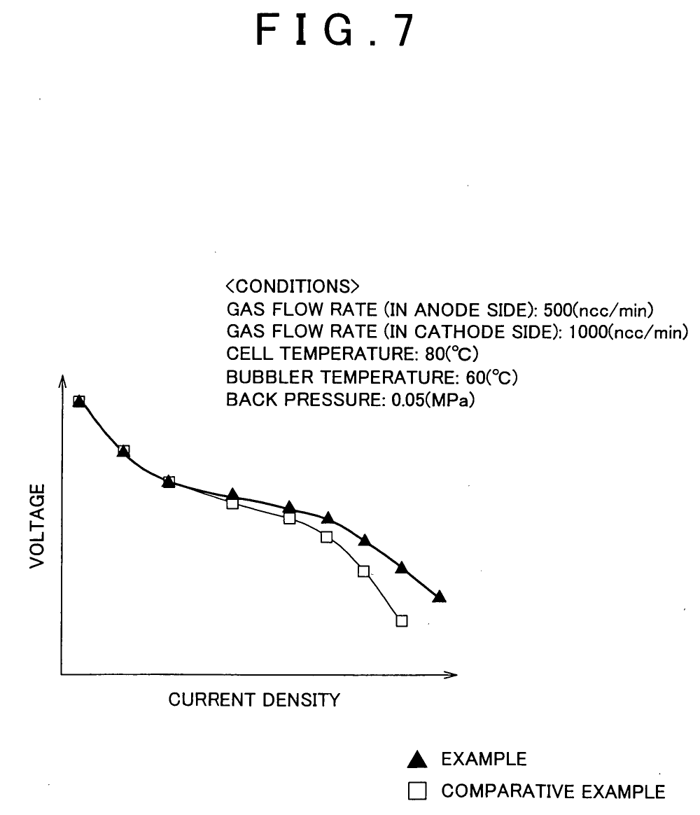

FIG. 7 is a chart showing the I-V characteristics (“I” stands for current density, and “V” stands for voltage) of the fuel cell 100 produced in an example of the invention and the I-V characteristics of a fuel cell produced in a comparative example. The fuel cell in the comparative example (not shown) included the gas diffusion layer that was produced using a method different from the method used for producing the gas diffusion layer of the fuel cell 100, and other configurations of the fuel cell in the comparative example were the same as those of the fuel cell 100. More specifically, in the fuel cell in the comparative example, gas diffusion paste was applied on carbon paper by a wet-application method, and then the carbon paper with the gas diffusion paste was dried so as to form the gas diffusion layer. In this process, the total content of the carbon black and PVDF in the gas diffusion paste, which was applied on the carbon paper, was adjusted to 0.5 mg/cm², which was equal to the density of the gas diffusion layer powder 300 in the example.

As exemplified in FIG. 7, the fuel cell 100 manufactured in the example and the fuel cell manufactured in the comparative example were operated under the following conditions: the flow rate of fuel gas (hydrogen gas) in the anode side was 500 ncc/min; the flow rate of oxidation gas (air) in the cathode side was 1000 ncc/min; a cell temperature was 80° C.; a bubbler temperature was 60° C. in each of the anode side and the cathode side; and a back pressure was 0.05 Mpa in each of the anode side and the cathode side. FIG. 7 shows the I-V characteristics of the fuel cell 100 in the example and the fuel cell in the comparative example operated under the operating conditions as described above. As shown in FIG. 7, at the same current density, the fuel cell 100 in the example exhibited higher voltage value than the voltage value of the fuel cell in the comparative example. The reason for this difference between the voltage values is considered as follows: in the fuel cell in the comparative example, the average size of the air holes inside the gas diffusion layer (i.e. the carbon paper) was several tens μm, and the average size of the air holes in the catalyst layer was approximately 0.01 μm. Therefore, there was a large difference between the size of the air holes in the gas diffusion layer and the size of the air holes in the catalyst layer, and thus, efficiency in the use of the reaction gas is low, resulting in deterioration of the power generation efficiency. In contrast, in the fuel cell 100 in the example, the average particle diameter of the catalyst powder 600 (approximately 2 μm) was approximately one-third of the average particle diameter of the gas diffusion layer powder 300 (approximately 6 μm). In other words, the size of the air holes 650 (shown in FIG. 6) in the catalyst layer was approximately one-third of the size of the air holes 350 in the gas diffusion layer. Accordingly, because there was no large difference between the size of the air holes in the gas diffusion layer and the size of the air holes in the catalyst layer, the efficiency in the use of the reaction gas was high, thereby improving the power generation efficiency. Furthermore, the gas diffusion layer in the fuel cell in the comparative example had thickness of 100 μm or more, including the thickness of the carbon paper that functions as the base material. In contrast, the gas diffusion layer in the fuel cell 100 in the example had thickness of approximately 80 μm. Accordingly, the electric resistance of the gas diffusion layer in the fuel cell 100 in the example was relatively small compared to the comparative example, thereby increasing the power generation efficiency.

It is to be understood that the invention is not limited to the described example and the embodiment, and the invention may be embodied in various manners within the scope of the invention. For example, the modifications as described below are included within the scope of the invention.

In the aforementioned embodiment, the gas diffusion layer powder 300 (as shown in FIG. 5) is deposited on the cathode-side catalyst layer 72 by electrostatic screening. However, instead of this, any other deposition method may be employed. For example, the gas diffusion layer powder 300 may be deposited using a spray method in which the gas diffusion layer powder 300 is sprayed on the cathode-side catalyst layer 72 by a spray. Alternatively, the gas diffusion layer powder 300 may be deposited on the cathode-side catalyst layer 72 using an electrophotographic method. In the electrophotographic method, the electrically charged gas diffusion layer powder 300 is electrostatically attached to a photoconductor drum that is electrically charged in a predetermined pattern, and the gas diffusion layer powder 300 attached on the photoconductor drum is transferred to the electrolyte membrane 60 with the cathode-side catalyst layer 72. In other words, generally, any deposition method may be used as a part of the MEA manufacturing method according to the invention, as long as the gas diffusion layer powder 300 is deposited on the cathode-side catalyst layer 72.

In the aforementioned embodiment, the water-repellent material (i.e. binder) is used in the gas diffusion layer slurry 200. However, the water-repellent material may be omitted. In this case, instead of the spray-drying method, for example, a mechanochemical method may be used to bind the particles of the conductive material, such as carbon black, so as to produce the powder of the conductive material. In the mechanochemical method, the gas diffusion layer powder is produced by applying mechanical energy to the conductive material so that the particles of the conductive material are consolidated and bound to each other. Examples of a powder manufacturing apparatus using the mechanochemical method include Mechanofusion System (registered trademark) made by Hosokawa Micron Corporation, and MECHANO MICROS made by Nara Machinery Co., Ltd. As is understood based on the embodiment and the modification examples described above, generally, any powder manufacturing method may be used as long as the gas diffusion layer powder is produced using the conductive material. The aforementioned mechanochemical method may be used as the method of producing the gas diffusion layer powder 300 or the catalyst powder 600, even when the water-repellent material is used.

In the aforementioned embodiment, the catalyst layer is formed by forming a deposit of the composite powder by the electrostatic screening in the manner similar to the manner in which the gas diffusion layer is formed. However, any other formation method may be used. For example, the catalyst layer may be formed by applying the catalyst paste on the electrolyte membrane 60 by a wet-application method, and drying the electrolyte membrane 60 with the catalyst paste applied.

In the aforementioned embodiment, the gas diffusion layer powder that forms the gas diffusion layer consists of one type of powder (the gas diffusion layer powder 300). However, plural types of powders may be used to form the gas diffusion layer, instead of using one type of powder. More specifically, for example, three types of powders with different particle diameters (for example, a first powder with a particle diameter of approximately 2 μm, a second powder with a particle diameter of approximately 6 μm, and a third powder with a particle diameter of approximately 10 μm) may be used to form the gas diffusion layer. In this case, the gas diffusion layer may be formed in a manner such that the first powder is deposited on the catalyst layer, and the second powder and the third powder are deposited thereon in this order. With this configuration, the size of the air holes is gradually reduced from the layer of the third powder to the layer of the first powder formed immediately on the catalyst layer, and therefore the reaction gas is more likely to diffuse in the entire catalyst layer. Not only plural types of powders with different particle diameters, but also plural types of powders with different compositions may be used to form the gas diffusion layer.

In the aforementioned embodiment, the average particle diameter of the gas diffusion layer powder is larger than the average particle diameter of the catalyst powder. However, the invention is not limited to this configuration, and the gas diffusion layer powder and the catalyst powder may have substantially the same average particle diameter, or the average particle diameter of the gas diffusion layer powder may be smaller than the average particle diameter of the catalyst powder. In these configurations as well, it is possible to reduce the thickness of the gas diffusion layer, because the gas diffusion layer is formed by the deposit of the gas diffusion layer powder.

While the invention has been described with reference to example embodiments thereof, it is to be understood that the invention is not limited to the described embodiments or constructions. On the other hand, the invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A method of manufacturing a membrane electrode assembly for a fuel cell, comprising:
producing a gas diffusion layer powder that is used to form a gas diffusion layer;
forming a catalyst layer on an electrolyte membrane; and
forming the gas diffusion layer on the catalyst layer by depositing the gas diffusion layer powder on the catalyst layer.

2. The method according to claim 1, wherein the gas diffusion layer powder is produced using a conductive material.

3. The method according to claim 2, wherein the gas diffusion layer powder is produced using a mixture containing the conductive material and a water-repellent material.

4. The method according to claim 2, wherein the gas diffusion layer powder is produced by spraying and drying a gas diffusion layer slurry containing the conductive material and a solvent.

5. The method according to claim 1, wherein the catalyst layer is formed by depositing a catalyst powder, which contains a catalyst-supported particle and an electrolyte, on the electrolyte membrane.

6. The method according to claim 5, wherein the catalyst powder is produced by spraying and drying a catalyst layer slurry containing the catalyst-supported particle, the electrolyte, and a solvent.

7. The method according to claim 5, wherein an average particle diameter of the gas diffusion layer powder is larger than an average particle diameter of the catalyst powder.

8. The method according to claim 7, wherein the average particle diameter of the gas diffusion layer-powder is two to three times larger than the average particle diameter of the catalyst powder.

9. The method according to claim 1, wherein:
the gas diffusion layer powder includes a first powder and a second powder; and
the first powder has a composition different from a composition of the second powder.

10. The method according to claim 1, wherein:
the gas diffusion layer powder includes a first powder and a second powder whose particle diameter is larger than a particle diameter of the first powder;
the first powder is deposited on the catalyst layer; and
the second powder is deposited on the first powder deposited on the catalyst layer.

11. A membrane electrode assembly for a fuel cell, comprising:
a catalyst layer formed by depositing a catalyst powder, which contains a catalyst-supported particle and an electrolyte, on an electrolyte membrane; and
a gas diffusion layer formed by depositing a gas diffusion layer powder, which contains a conductive material, on the catalyst layer.

12. The membrane electrode assembly according to claim 11, wherein an average particle diameter of the gas diffusion layer powder is larger than an average particle diameter of the catalyst powder.
